(19) United States
(12) Patent Application Publication
(10) Pub. No.: US 2013/0021800 A1
(43) Pub. Date: Jan. 24, 2013

(54) DUAL USE LIGHT SOURCE IN AN ELECTRONIC DEVICE

(71) Applicant: J. Stephen Wells, Flowery Branch, GA (US)

(72) Inventor: J. Stephen Wells, Flowery Branch, GA (US)

(21) Appl. No.: 13/185,068

(22) Filed: Jul. 18, 2011

(51) Int. Cl. F21W 111/00

(52) U.S. Cl. 362/276

(57) ABSTRACT

Methods and apparatuses are provided for using a single light source to convey the status of multiple operational modes of an electronic device and to illuminate a trademark to reduce the power usage, size, and cost of the device.

### TECHNICAL FIELD

This disclosure relates to a light source in an electronic device.

### BACKGROUND

Telecommunication equipment such as cable modems, for example, typically include multiple status indicators to convey the state (e.g., in progress or complete) of multiple operational modes, respectively, of the equipment.

For example, in a DOCSIS-based system, a cable modem (CM) can be used to send traffic to and receive traffic from a headend over a cable network. Traffic transferred from the headend to the CM can be said to travel in a downstream direction on one or more downstream channels; conversely, traffic transferred from the CM to the headend can be said to travel in an upstream direction on one or more upstream channels. Once the CM receives traffic from the headend, the CM can deliver the traffic to another device such as a home gateway, a personal computer, or IP telephone. To become fully operational to receive and send traffic over the cable network, the CM goes through an initialization stage and registration stage. During the initialization stage, the CM searches for and acquires a downstream and upstream channel(s) on which to receive and transmit traffic, respectively. Also during the initialization stage, the CM acquires an IP address and configuration file. After the initialization stage, the CM registers with the headend as described in the DOCSIS specifications (e.g., DOCSIS 1.0, 1.1, 2.0 and 3.0), which are hereby incorporated by reference in their entirety. After the initialization and registration stages are complete, the CM becomes fully operational and can transmit and receive traffic over the cable network. Status indicators on the CM can be used to convey the state of the operational modes of the CM. For example, status indicators can be used to, for example, convey that the CM is searching for a downstream (DS) channel, that the CM is searching for an upstream (US) channel, whether the CM has acquired a downstream channel to receive data, whether the CM has acquired an upstream channel to send data, that the CM is registering with the headend, whether the CM is registered with the headend and is fully operational, whether the CM is connected to another device, whether data is being transferred between the CM and a another device, etc.

Typically, a telecommunication device will have a status indicator for each operational mode desired to be depicted. For example, a CM can have at least four distinct status indicators to convey respectively the downstream connectivity status of the CM, the upstream connectivity status of the CM, the registration status of the CM, and the connectivity status of the CM with another device, for example. The status of a particular operational mode can be conveyed by the state (e.g., on, off, flashing) of the status indicator. For example, a blinking DS status indicator (i.e., the status indicator used to indicate the downstream connectivity status) can be used to convey that the CM is searching for and acquiring a downstream channel while a lit but non-flashing DS status indicator can be used to convey that the CM has acquired a downstream channel to receive data. Similarly, a blinking US status indicator (i.e., the status indicator used to indicate upstream connectivity status) can be used to convey that the CM is searching for and acquiring an upstream channel while a lit but non-flashing US status indicator can be used to convey that the CM has acquired a upstream channel to send data.

Status indicators are typically small round or rectangular lights on the device faceplate. A status indicator typically is lit from a light source inside the device where the light from the light source inside the device travels through a light pipe to the status indicator location on the faceplate. The light source inside the device can be from a light emitting diode (LED), for example, mounted on a printed circuit board in the device. The printed circuit board can contain circuitry that includes software that causes the LED to emit light to indicate a status of the device. As discussed above, a telecommunication device will have a status indicator for each operational mode desired to be depicted; thus, the device will have multiple light sources (e.g., multiple LEDs) to convey multiple operational modes, respectively.

Typically, the manufacturer of a device will place its brand or trademark on the device. If the brand/trademark is lit, it is lit by a light source that is separate from the light sources for the status indicators.

Using multiple light sources for the status indicators and the brand/trademark increases the power usage, size, and cost of the device. It can be desirable to reduce the power used, space used, and cost to provide status indicators and an illuminated brand/trademark for a device.

### BRIEF DESCRIPTION OF THE DRAWINGS

FIGS. 1A-C illustrate an existing CM having multiple status indicators.

FIGS. 2A-C illustrate an example CM having a single light source to convey the status of multiple operational modes of the CM 200 and to illuminate a brand/trademark.

### DETAILED DESCRIPTION

Various implementations of this disclosure provide a single light source to convey the status of multiple operational modes of a telecommunication device and to illuminate a trademark to reduce the power usage, size, and cost of the device.

Although this disclosure makes reference to a DOCSIS-based system and CMs, this disclosure is not intended to be limited to a DOCSIS-based system or CMs. This disclosure can be applied to any electronic device and in particular telecommunication devices. Furthermore, this disclosure is not intended to be limited to any particular type of light source.

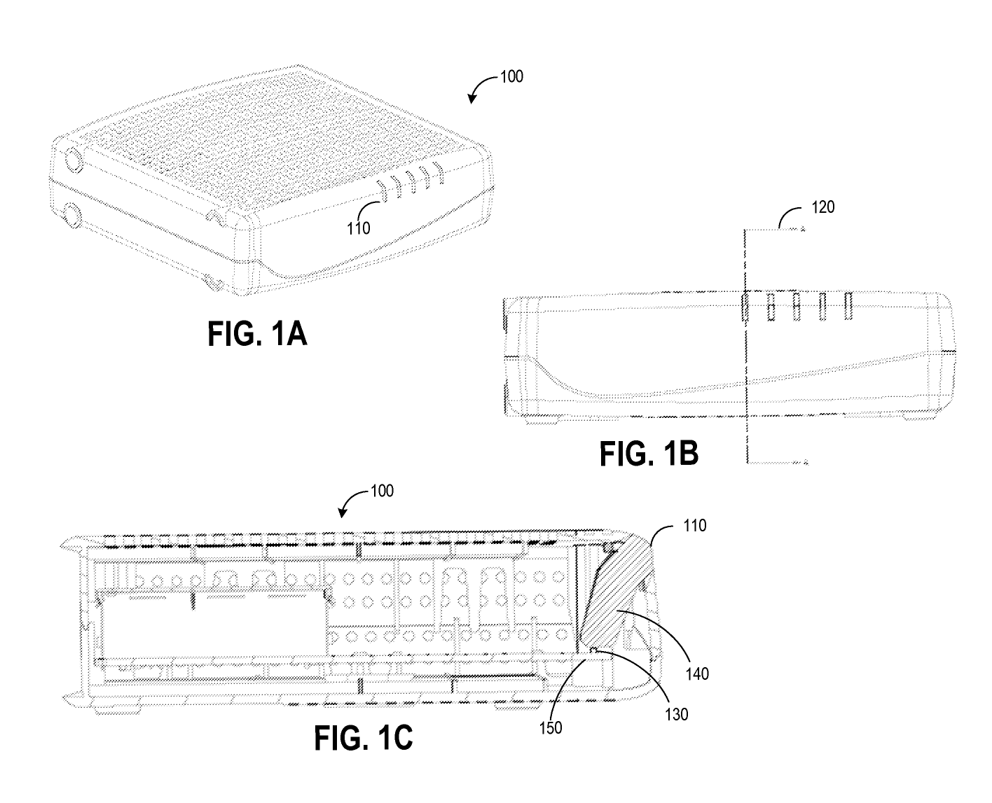

FIG. 1A illustrates an example CM 100 having multiple status indicators 110. The CM 100 includes five distinct status indicators 110 to convey the status of five operational modes, respectively, of the CM 100.

FIG. 1B illustrates a front view of the CM 100 of FIG. 1, and FIG. 1C illustrates a cross-sectional view of the CM 100 at the cross-section 120 indicated in FIG. 1B. As shown in FIG. 1C, a status indicator 110 is lit from a light source 130 inside the CM 100 where the light from the light source 130 inside the CM 100 travels through a light pipe 140 to the status indicator location 110 on the faceplate of the CM 100. The light source 130 inside the CM 100 can be from a LED, for example, mounted on a printed circuit board 150 in the CM 100. The printed circuit board 150 contains circuitry that includes software that causes the light source 130 to emit light to indicate an operational mode of the CM 100. Although not shown, the CM 100 has multiple light sources (one for each status indicator) to indicate multiple operational modes, respectively, of the CM 100. Using multiple light sources for the status indicators of the CM 100 increases the power usage, size, and cost of the CM 100.

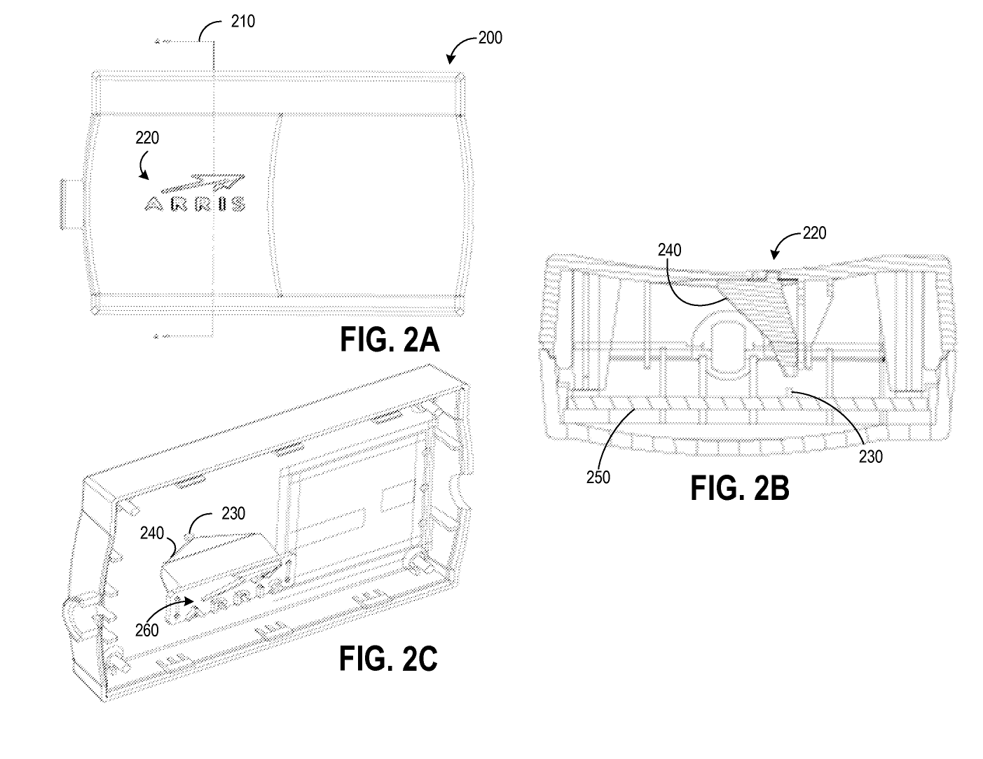

FIGS. 2A and 2B illustrate an example CM 200 that uses a single light source to convey the status of multiple operational modes of the CM 200 and to illuminate a brand/trademark.

FIG. 2A illustrates a front view of the CM 200 of FIG. 2, and FIG. 2B illustrates a cross-sectional view of the CM 200 at the cross-section 210 indicated in FIG. 2A. The CM 200 includes one status indicator 220 in the shape of a brand/trademark to convey the status of multiple operational modes of the CM 200.

As shown in FIG. 2B, the status indicator 220 is lit from a light source 230 inside the CM 200 where the light from the light source 230 inside the CM 200 travels through a light pipe 240 to the status indicator location 220 on the faceplate of the CM 200. The light source 230 inside the CM 200 can be from a LED, for example, mounted on a printed circuit board 250 in the CM 200. The printed circuit board 250 contains circuitry that includes software that causes the light source 230 to emit light to indicate multiple operational modes of the CM 200. For example, in one implementation, the light source 230 is programmed to flash at a first frequency when the CM is initializing and registering, to turn on without flashing when the CM is fully operational, and to flash at a second frequency when data is being transferred between the CM and another device, for example. One of ordinary skill in the art would know how to program a light source to emit light to indicate multiple operational modes.

FIG. 2C illustrates an example implementation of the light pipe 240 in more detailed. As shown in FIG. 2C, the brand/trademark to be lit can be embossed on the end of the light pipe 240 at which light exits. The embossed brand/trademark 260 can then be fitted into a cut out of the brand/trademark on the outer surface the CM 200.

The example CM 200 reduces the power usage, size, and cost of existing CM having status indicators and, in some implementations, illuminated brands/trademarks.

Implementations of the device of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

The processes and logic flows described in this specification can be performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

While this specification contains many specific implementation details, these should not be construed as limitations on the scope of any invention or of what may be claimed, but rather as descriptions of features that may be specific to particular implementations of particular inventions.

1. An electronic device having a plurality of operational modes, the electronic device comprising:
a status indicator configured in the shape of a brand or trademark;
a light source to supply light to the status indicator wherein the light source is configured to emit light at a plurality of frequencies corresponding to a plurality of operational modes of the electronic device, respectively.

2. The electronic device of claim 1 wherein the electronic device is a telecommunication device.

3. The electronic device of claim 2 wherein the electronic device is a cable modem.

4. The electronic device of claim 3 wherein the light source emits a light at a first frequency when the CM is in a first operational state, emits a light at a second frequency when the CM is in a second operational state, and emits a light at a third frequency when the CM is in a third operational state.

5. The electronic device of claim 4 wherein the light source emits a light at a first frequency when the CM is initializing and registering, emits a light at a second frequency when the CM is fully operational after initializing and registering, and emits a light at a third frequency when the CM is sending or receiving data after becoming fully operational.

6. The electronic device of claim 5 wherein one frequency of the plurality of frequencies is zero, which corresponds to a light that does not flash.
